(19) United States
(12) Patent Application Publication
(10) Pub. No.: US 2014/0153938 A1
(43) Pub. Date: Jun. 5, 2014

(54) IMAGE HEATING APPARATUS

(71) Applicant: CANON KABUSHIKI KAISHA, Tokyo (JP)

(72) Inventor: Shutaro Saito, Kashiwa-shi (JP)

(73) Assignee: CANON KABUSHIKI KAISHA, Tokyo (JP)

(21) Appl. No.: 14/090,257

(22) Filed: Nov. 26, 2013

(30) Foreign Application Priority Data
Nov. 27, 2012 (JP) 2012-258331

(51) Int. Cl. G03G 15/00

(52) U.S. Cl. CPC G03G 15/55
USPC 399/33

(57) ABSTRACT

An image heating apparatus includes: a rotatable heating member; a driving mechanism; a rotatable pressing member; a first contact-and-separation mechanism; a rotatable externally-heating member; a second contact-and-separation mechanism; a detecting portion configured to detect information corresponding to a drive load exerted on the driving mechanism; and a controller configured to actuate, when the information is detected by the detecting portion, the driving mechanism for a predetermined time in a state in which the rotatable externally-heating member is press-contacted to the rotatable heating member and in which the rotatable pressing member is spaced from the rotatable heating member. The controller controls, depending on an output of the detecting portion, whether or not image heating is prohibited.

### FIELD OF THE INVENTION AND RELATED ART

The present invention relates to an image heating apparatus for heating a toner image on a sheet.

In a conventional image forming apparatus of an electrophotographic type, the toner image formed on a recording material (sheet) is fixed by a fixing device (image heating apparatus).

In a fixing device described in Japanese Laid-Open Patent Application (JP-A) 2005-316421, an outer surface of a fixing roller (rotatable heating member) is heated by two externally heating rollers (externally-heating members) in contact with the fixing roller while being rotated by rotation of the fixing roller.

Here, when the externally heating rollers are used for a long term exceeding a recommended period thereof, there is a fear that a drive load (under which the externally heating rollers are rotated by rotation of the fixing roller) exerted on a motor for driving the fixing roller is increased. Further, in the worst case, there is a fear that an externally heating roller bearing is broken to result in breaking of another part.

Therefore, in order to prevent such a problem from occurring, the drive load (torque) exerted on the motor may preferably be detected. Accordingly, when the drive load is detected, detection is made in a state in which the externally heating rollers are press-contacted to the fixing roller.

However, when the drive load is intended to be detected in a state in which a pressing roller is contacted to the fixing roller, the following problem can occur. That is, the drive load exerted on the motor includes a drive load resulting from the pressing roller, and therefore it is difficult to detect the drive load resulting from the pressing roller with high accuracy.

### SUMMARY OF THE INVENTION

According to an aspect of the present invention, there is provided an image heating apparatus comprising: a rotatable heating member configured to heat a toner image on a sheet at a nip; a driving mechanism configured to drive the rotatable heating member; a rotatable pressing member configured to form the nip in press-contact with the rotatable heating member while being rotated by rotation of the rotatable heating member; a first contact-and-separation mechanism configured to move the rotatable pressing roller toward and away from the rotatable heating member; a rotatable externally-heating member provided outside the rotatable heating member and configured to heat the rotatable heating member in press-contact with the rotatable heating member while being rotated by rotation of the rotatable heating member; a second contact-and-separation mechanism configured to move the rotatable externally-heating member toward and away from the rotatable heating member; a detecting portion configured to detect information corresponding to a drive load exerted on the driving mechanism; and a controller configured to actuate, when the information is detected by the detecting portion, the driving mechanism for a predetermined time in a state in which the rotatable externally-heating member is press-contacted to the rotatable heating member and in which the rotatable pressing member is spaced from the rotatable heating member, wherein the controller controls, depending on an output of the detecting portion, whether or not image heating is prohibited.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is an illustration of a structure of an image forming apparatus.

FIG. 2 is an illustration of a structure of a fixing device (apparatus).

FIG. 3 is a perspective view of the fixing device.

FIG. 4 is a block diagram of a control system of the image forming apparatus.

FIGS. 5(a), 5(b), and 5(c) are illustrations each showing positions of a pressing roller and externally heating rollers.

FIGS. 6(a) and 6(b) are graphs each for illustrating an effect of executing an operation in a load detecting mode in a spaced state of the pressing roller.

FIG. 7 is a flowchart of control in Embodiment 1.

FIG. 8 is a flowchart of control in Embodiment 2.

FIGS. 9(a), 9(b), and 9(c) are illustrations each showing display at a user operating portion.

FIG. 10 is a schematic diagram showing the relationship between FIG. 10A and FIG. 10B; FIG. 10A is part of a flowchart of control in Embodiment 3; and FIG. 10B is the remainder of the flowchart shown in FIG. 10A.

FIG. 11 is a schematic diagram showing the relationship between FIG. 11A and FIG. 11B; FIG. 11A is part of a flowchart of control in Embodiment 4; and FIG. 11B is the remainder of the flowchart shown in FIG. 11A.

FIG. 12 is an illustration of a structure of a fixing device in Embodiment 5.

### DESCRIPTION OF THE EMBODIMENTS

Embodiments of the present invention will be specifically described below with reference to the drawings.

### <Image Forming Apparatus>

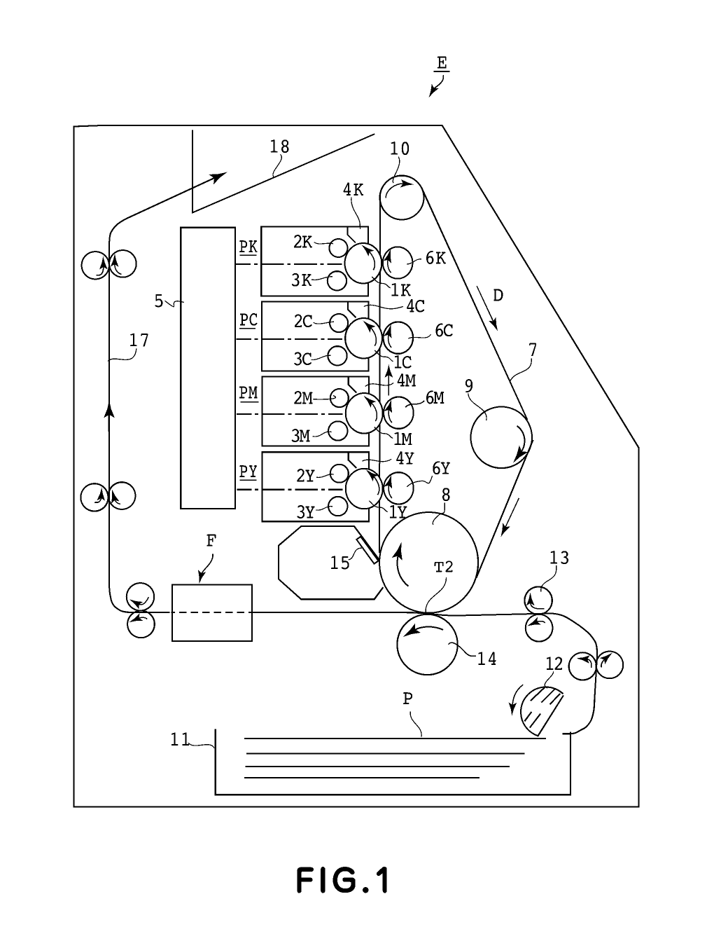

FIG. 1 is an illustration of a structure of an image forming apparatus E. As shown in FIG. 1, the image forming apparatus E is a tandem-type full-color printer of an intermediary transfer type in which image forming portions PY, PM, PC and PK for yellow, magenta, cyan and black, respectively are arranged along an intermediary transfer belt 7.

In the image forming portion PY, a yellow toner image is formed on a photosensitive drum 1Y, and then is transferred onto the intermediary transfer belt 7. In the image forming portion PM, a magenta toner image is formed on a photosensitive drum 1M, and then is transferred onto the intermediary transfer belt 7. In the image forming portions PC and PK, a cyan toner image and a black toner image are formed on photosensitive drums 1C and 1K, respectively, and then are transferred onto the intermediary transfer belt 7.

The intermediary transfer belt 7 is stretched by a driving roller 10, a secondary transfer opposite roller 8 and a tension roller 9, and is rotated in an arrow D direction by the driving roller 10. A recording material P is taken out, by a sheet feeding roller 12, from a recording material cassette 11 one by one by and is in stand-by between a registration roller pair 13. The recording material P is sent by the registration roller pair 13 to a secondary transfer portion T2, and in a process in which the recording material P is conveyed through the secondary transfer portion T2, the toner images are transferred from the intermediary transfer belt 7. The recording material P on which the toner images are transferred, is conveyed into a fixing device (apparatus) F and is heated and pressed by the fixing device F to fix an image thereon. The recording material P on which the image is fixed is discharged onto an external tray 18 through a discharging conveyance passage 17.

The image forming portions PY, PM, PC and PK have the substantially same constitution except that the colors of toners of yellow, magenta, cyan and black used in developing devices 3Y, 3M, 3C and 3K are different from each other. In the following description, the image forming portion PY will be described and other image forming portions PM, PC and PK will be omitted from redundant description.

The image forming portion PY includes the photosensitive drum 1Y around which a charging roller 2Y, an exposure device 5, the developing device 3Y, a transfer roller 6Y, and a drum cleaning device 4Y are provided. The charging roller 2Y electrically charges the surface of the photosensitive drum 1Y to a uniform potential. The exposure device 5 writes (forms) an electrostatic image for an image on the photosensitive drum 3Y by scanning with a laser beam. The developing device 3Y develops the electrostatic image into the toner image on the photosensitive drum 1Y by supplying the toner to the electrostatic image. The transfer roller 6Y is supplied with a DC voltage, so that the toner image on the photosensitive drum 1Y is transferred onto the intermediary transfer belt 7.

### Embodiment 1

### (Fixing Device)

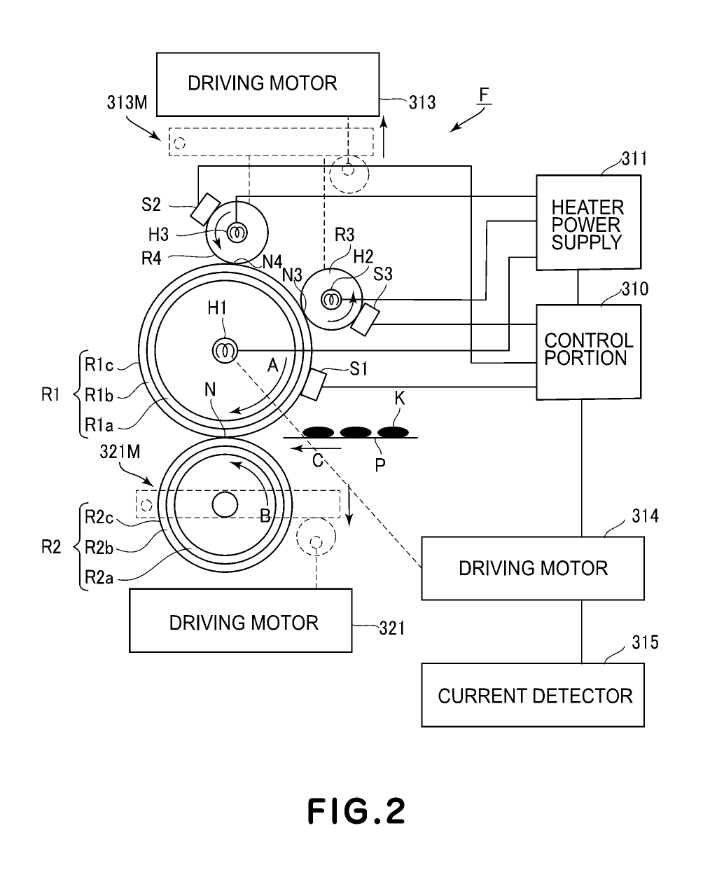

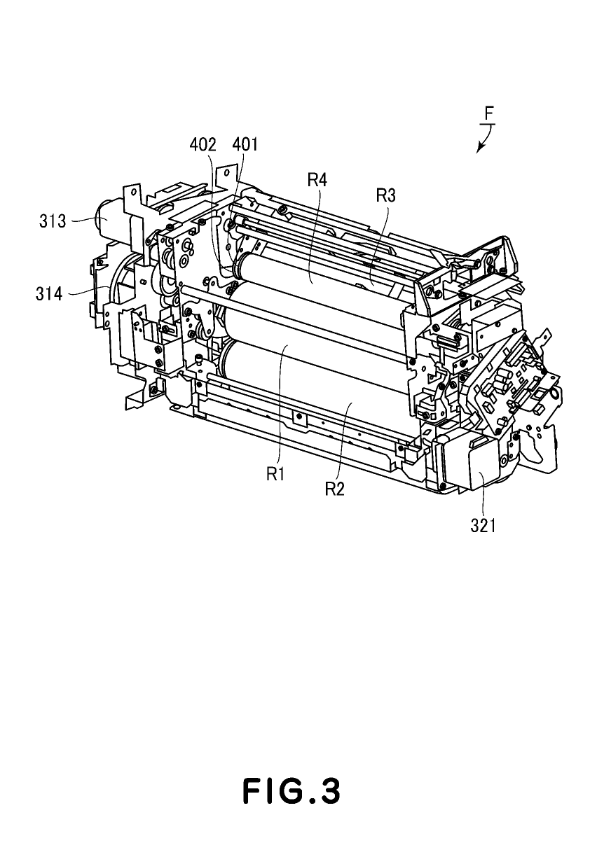

FIG. 2 is an illustration of a structure of the fixing device functioning as an image heating apparatus. FIG. 3 is a perspective view of the fixing device.

As shown in FIG. 2, in the fixing device F, a nip N is for the recording material P formed by causing a pressing roller R2 to press-contact a fixing roller R1. At the nip N, the recording material P on which an unfixed toner K is carried is nipped and conveyed, and an image is fixed on the recording material P by melting the unfixed toner on the recording material P.

The fixing roller R1 functioning as a rotatable heating member is prepared by providing a 2.0 mm-thick silicone rubber elastic layer Rib on a core metal Ria formed with an aluminum pipe of 60 mm in diameter, and then by coating the surface of the elastic layer Rib with a parting layer Ric formed with a 50 μm-thick PFA tube.

The silicone rubber of the elastic layer Rib is 0.5 W/m.K in thermal conductivity.

The fixing roller R1 is rotated by a fixing roller driving motor 314 in an arrow A direction at a process speed of 500 mm/sec.

The pressing roller R2 functioning as a rotatable pressing member is prepared by providing a 1.9 mm-thick silicone rubber elastic layer R2b on a core metal R2a formed with an aluminum pipe of 60 mm in diameter, and then by coating the surface of the elastic layer R2b with a parting layer R2c formed with a 50 μm-thick PFA tube.

The silicone rubber of the elastic layer R2b is 0.5 W/m.K in thermal conductivity. The pressing roller R2 is rotated in an arrow B direction by rotation of the fixing roller R1 in contact with the fixing roller R1.

The pressing roller R2 is driven by a pressing mechanism 321M using an eccentric cam functioning as a contact-and-separation mechanism (moving mechanism) and is moved toward and away from the fixing roller R1. The pressing mechanism 321M presses the pressing roller R2 at predetermined pressure against the fixing roller R1, so that the nip N is formed between the fixing roller R1 and the pressing roller R2. The (press-contact) pressure at the nip N is set at 980N (100 kgf). The pressing mechanism 321M also functions as a mechanism for moving the pressing roller R2 toward and away from the fixing roller R1.

A halogen heater H1 is provided non-rotatably inside the core metal R1a of the fixing roller R1. A thermistor S1 is provided in contact with the fixing roller R1 to detect a surface temperature of the fixing roller R1. A controller (control portion) 310 effects ON/OFF control of the halogen heater H1 depending on a detected temperature by the thermistor S1, thus maintaining the surface temperature of the fixing roller R1 at a predetermined target temperature depending on the type of the recording material P.

The controller 310 functioning as an executing portion effects ON/OFF control of the halogen heater H1 on the basis of a signal from the thermistor S1 so that suitable heating depending on the type of the recording material P can be made. The controller 310 supplies electric power to the halogen heater H1 through a heater electric power supplying portion 311. During continuous image formation, sheet of the recording material P on which the unfixed toner image is transferred successively pass through the nip N where the pressing roller R2 is press-contacted to the fixing roller R1. A toner K on the recording material P is melt-fixed by heat of the fixing roller R1 heated by the halogen heater H1 and a press-contact force of the pressing roller R2 press-contacted to the fixing roller R1, so that the image is fixed on the recording material P.

### (Externally Heating Roller)

As shown in FIG. 2, with speed-up of heating (treatment) in recent years, in order to supply a heat quantity which cannot be supplied by only the fixing roller R1, externally heating rollers R3 and R4 heated by halogen heaters H2 and H3, respectively, are contacted to the fixing roller R1. In order to properly keep the surface temperature of the fixing roller R1, the surface of the fixing roller R1 is directly heated by the externally heating rollers R3 and R4.

The externally heating roller R3 functioning as a rotatable externally-heating member includes a cylindrical aluminum-made core metal of 30 mm in outer diameter, 3 mm in thickness and 350 mm in length. The core metal is coated with a 20 μm-thick fluorine-containing resin tube as a heat-resistant slidable layer. Inside the core metal of the externally heating roller R3, the halogen heater H2 is incorporated.

The externally heating roller R4 is controlled substantially similarly as the externally heating roller R3, and is disposed upstream of the externally heating roller R3 with respect to a rotational direction of the fixing roller R1.

The externally heating roller R4 includes a cylindrical aluminum-made core metal of 30 mm in outer diameter, 3 mm in thickness and 350 mm in length. The core metal is coated with a 20 μm-thick fluorine-containing resin tube as a heat-resistant slidable layer. Inside the core metal of the externally heating roller R4, the halogen heater H3 is incorporated.

The externally heating rollers R3 and R4 are movable toward and away from the fixing roller R1 by a contact-and-separation mechanism 313M using an eccentric cam functioning as a contact-and-separation mechanism (moving mechanism). The contact-and-separation mechanism 313M also functioning as a mechanism for pressing the externally heating rollers R3 and R4 toward the fixing roller R1. The contact-and-separation mechanism 313M presses the externally heating rollers R3 and R4 at a total pressure of 196N (about 20 kgf). That is, the total pressure at which the externally heating rollers R3 and R4 are pressed against the fixing roller R1 smaller than the total pressure at which the pressing roller R2 is pressed against the fixing roller R1.

The externally heating rollers R3 and R4 are driven by an externally heating roller mounting and demounting driving motor 313 and thus are pressed against the fixing roller R1 at predetermined pressure to form nips N3 and N4, thus heating the surface of the fixing roller R1. The externally heating rollers R3 and R4 are rotated by rotation of the fixing roller R1 in contact with the fixing roller R1.

The controller 310 functioning as the executing portion effects, on the basis of signals from thermistors S2 and S3, ON/OFF control of the halogen heaters H2 and H3 so that surface temperatures of the externally heating rollers R3 and R4 are predetermined temperatures. The controller 310 supplies electric power to the halogen heaters H2 and H3 through the heater electric power supplying portion 311. The target temperatures of the externally heating rollers R3 and R4 are set at values higher than the target temperature of the fixing roller R1. This is because when the temperatures of the externally heating rollers R3 and R4 are kept at the higher values than the temperature of the fixing roller R1, a response (heat-sensitive accuracy) to a lowering in surface temperature of the fixing roller R1 contacted to the recording material P is good, and thus heat can be supplied from the externally heating rollers R3 and R4 to the fixing roller R1. Specifically, the target temperatures of the externally heating rollers R3 and R4 are set at 200° C. which is 40° C. higher than the target temperature of 180° C. of the fixing roller R1.

As shown in FIG. 3, at each of end portions of the externally heating rollers R3 and R4 with respect to an axial direction, a supporting flange member 401 for rotatably supporting the externally heating roller R3 and R4 is provided. As the supporting flange member 401, a rolling-element bearing (ball bearing) is used. The rolling-element bearing produces smooth rolling motion by disposing rolling elements, between metal-made inner and outer rings, held by a holding device with a certain spacing so as not to contact each other.

Between the supporting flange member 401 and the externally heating roller R3 or R4, a heat-resistant bush 402 of a thermoplastic resin is provided so that heat of the externally heating roller R3 or R4 is less conducted to a frame of the fixing device F. The heat-resistant bush 402 is formed of a heat-resistant resin material having a heat-resistant temperature of 230° C. to 270° C. so as to withstand the heat of the externally heating roller R3 or R4. The material for the heat-resistant bush 402 is a PPS (polyphenylene sulfide)-based composite resin. The materials of no problem if the material is the heat-resistant resin material or a resin material having high heat resistance, and may also be a fluorine-containing resin material.

### (Controller)

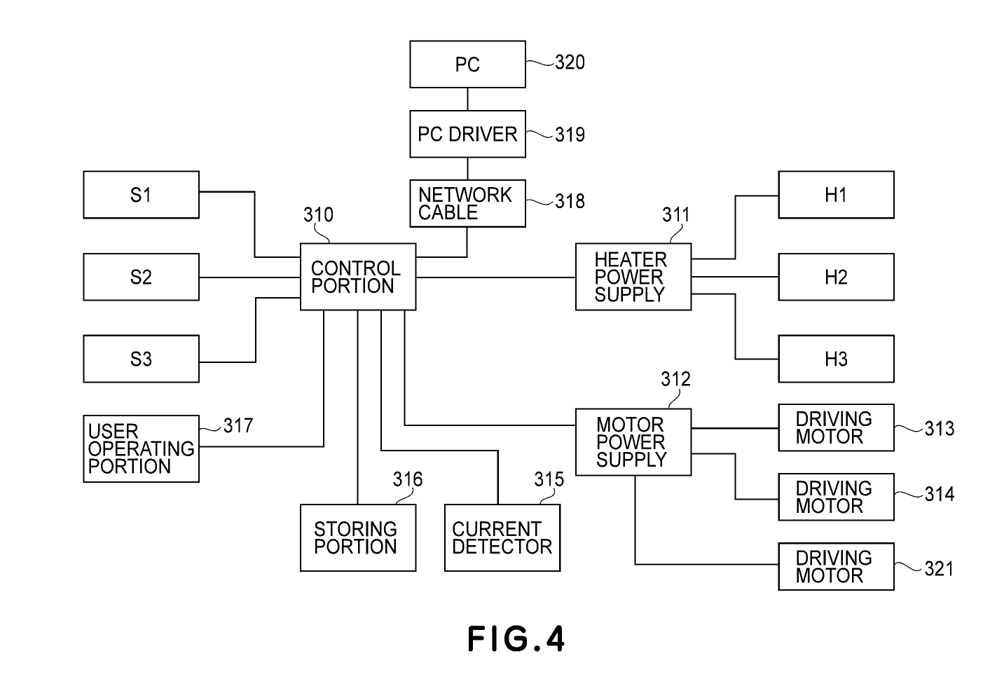

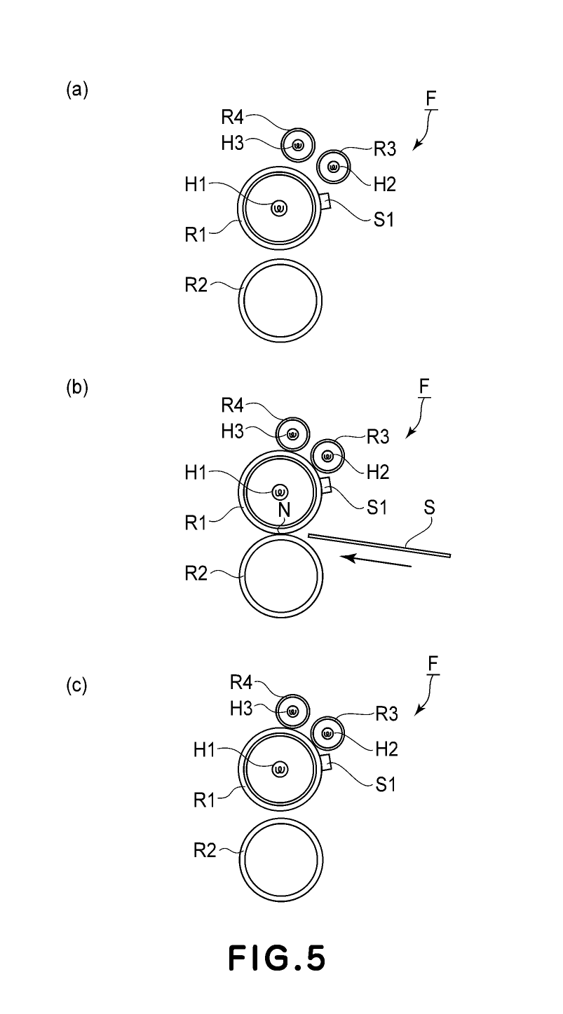

FIG. 4 is a block diagram of a control system of the image forming apparatus. FIGS. 5(a), 5(b), and 5(c) are illustrations each showing positions of the pressing roller and the externally heating rollers.

As shown in FIG. 4, the controller 310 functioning as the executing portion and a sending portion controls a motor electric power supplying portion 312 to actuate the fixing roller driving motor 314, so that the fixing roller R1 is rotated at a certain speed.

The controller 310 controls rotation and stop (of rotation of) an externally heating roller mounting and demounting driving motor 313 through the motor electric power supplying portion 312 to actuate the contact-and-separation mechanism 313M using the eccentric cam, so that the externally heating rollers R3 and R4 are moved toward and away from the fixing roller R1.

The controller 310 controls rotation and stop (of rotation of) a pressing roller mounting and demounting driving motor 321 through the motor electric power supplying portion 312 to actuate a pressing mechanism 321M using the eccentric cam, so that the pressing roller R2 is moved toward and away from the fixing roller R1.

The controller 310 is connected with an input terminal 320 such as a PC (personal computer) via a network cable 318 and a driver 319. A user operates the input terminal 320, so that an image forming job is sendable to the image forming apparatus E.

At a user operating portion 317, the user is capable of inputting the contents of the image forming job, and the type, basis weight size and the like of the recording material P by operating a touch panel. At the user operating portion 317, various pieces of information are displayed on a screen of the touch panel and are notified to the user.

As shown in FIG. 5(a), in a stand-by state, the pressing roller R2 and the externally heating rollers R3 and R4 take a first position where these rollers are spaced from the fixing roller R1. In the first position, the pressing roller R2 and the externally heating rollers R3 and R4 are spaced from the fixing roller R1. The stand-by state in a print stand-by state before a power source of the image forming apparatus E is turned on to start printing. The controller 310 sets the target temperature of the fixing roller R1 at 200° C. during the stand-by state.

As shown in FIG. 5(b), during continuous image formation, the pressing roller R2 and the externally heating rollers R3 and R4 take a second position where these rollers are contacted to the fixing roller R1. In the second position, the pressing roller R2 and the externally heating rollers R3 and R4 are contacted to the fixing roller R1. In the stand-by state, when print start input is made, in the case of a plain paper, the target temperature for temperature adjustment of the fixing roller R1 is set at 180° C., and the target temperatures for temperature adjustment of the externally heating rollers R3 and R4 are set at 220° C.

### Comparison Example

As shown in FIG. 2, in Comparison example, by using an output of a fixing roller driving motor current detecting portion 315, failure detection of the externally heating rollers R3 and R4 is made. The fixing roller driving motor current detecting portion 315 detects a value of a current supplied to the fixing roller driving motor 314 correspondingly to a real-time output torque value of the fixing roller driving motor 314.

However, to the fixing roller R1, not only the externally heating rollers R3 and R4 but also the pressing roller R2 to be press-contacted at relatively large pressure are press-contacted. For that reason, in the case where drive detection is made in a state in which the pressing roller R2 is press-contacted to the fixing roller R1, even when the externally heating rollers R3 and R4 are increased in drive load, a proportion of the drive load increase to a drive load increase as a whole is small, and therefore it becomes difficult to find the drive load increase. Further, when the cleaning device and another rotatable member are, in addition to the pressing roller R2, press-contacted to the fixing roller R1, it is not easy to track down the cause of the drive load increase detected by the fixing roller driving motor current detecting portion 315.

Therefore, in control in the following embodiments, as shown in FIG. 5(c), in an operation in a load detecting mode, a third position where the pressing roller R2 is spaced from the fixing roller R1 and only the externally heating rollers R3 and R4 are contacted to the fixing roller R1 is taken. In the third position, the pressing roller R2 is spaced from the fixing roller R1 and only the externally heating rollers R3 and R4 are contacted to the fixing roller R1. The drive load detection using the output of the fixing roller driving motor current detecting portion 315 in the third position is performed, and therefore it is possible to easily detect the drive load increase of the externally heating rollers R3 and R4. In the case where a large drive load increase is confirmed, the cause of the drive load increase can be easily identified that the cause is the externally heating rollers R3 and R4.

### (Effect of Spacing Pressing Roller)

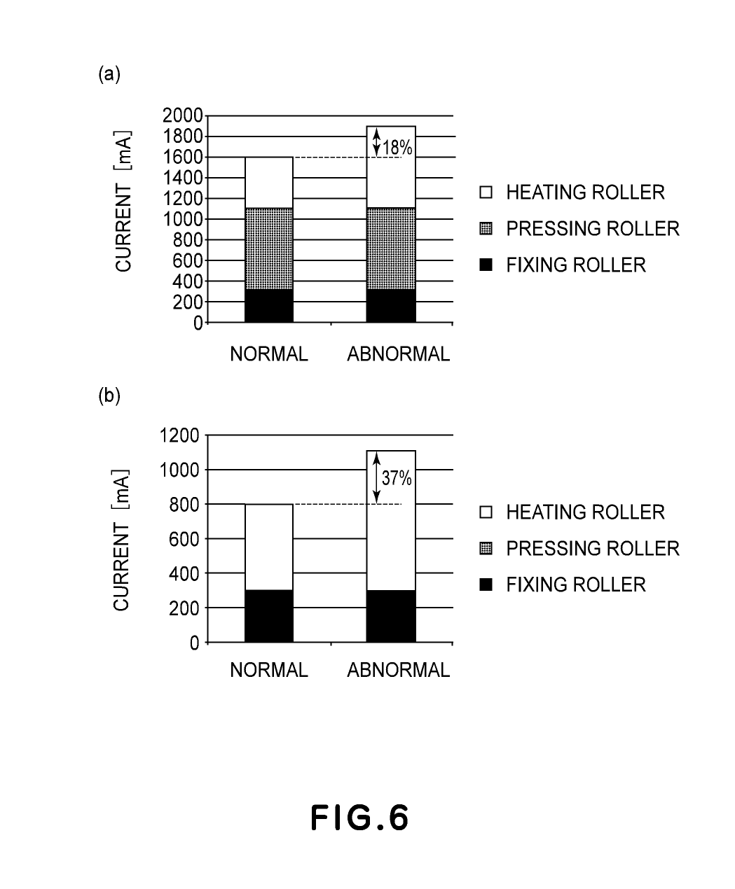

FIGS. 6(a) and 6(b) are illustrations of an effect of execution of an operation in a load detecting mode in a state in which the pressing roller is spaced. In FIG. 6(a) shows the contents of a current value of the fixing roller driving motor in the second position, and FIG. 6(b) shows the contents of a current value of the fixing roller driving motor in the third position.

As shown in FIG. 2, in Embodiment 1, the fixing roller R1 is driven and rotated by the fixing roller driving motor 314 as a motor to heat an image surface of the recording material P. The pressing roller R2 is disposed movably toward and away from the fixing roller R1 to form the nip N for the recording material P in contact with the fixing roller R1 during the heating of the recording material P. The externally heating rollers R3 and R4 are disposed movably toward and away from the fixing roller R1, and is rotated by rotation of the fixing roller R1 in contact with the fixing roller R1 during the heating of the recording material P.

The fixing roller driving motor current detecting portion 315 functioning as a detecting portion detects drive rotation information of the fixing roller R1 by the fixing roller driving motor 314. The controller 310 is capable of executing the operation in the load detecting mode as an example of a detecting mode for detecting a driving torque, of the fixing roller driving motor 314, as an example of first drive rotation information by the fixing roller driving motor current detecting portion 315. In the operation in the detecting mode, the fixing roller driving motor 314 is operated over a predetermined time in a state in which the pressing roller R2 is spaced from the fixing roller R1 and in which the externally heating rollers R3 and R4 are contacted to the fixing roller R1. The controller 310 is capable of discriminating (diagnosing) an abnormal rotation state of the externally heating rollers R3 and R4 on the basis of the driving torque of the fixing roller driving motor 314. The driving torque of the fixing roller driving motor 314 can be replaced with (1) a rotation speed of the fixing roller R1, (2) the number of fluctuations of the rotation speed of the fixing roller R1, and (3) the number of fluctuations of the driving torque of the fixing roller driving motor 314.

At the user operating portion 317 functioning as an operating portion, start of the operation in the load detecting mode can be instructed by an operator and a state of the fixing device F can be displayed. Specifically, the controller 310 effects display for urging the operator (user) to replace the externally heating rollers R3 and R4 in the case where the state of the externally heating rollers R3 and R4 is discriminated as being abnormal.

The externally heating rollers R3 and R4 heat the surface of the fixing roller R1 during the heating of the recording material P. The controller 310 executes the operation in the load detecting mode in a state in which the externally heating rollers R3 and R4 heat the surface of the fixing roller 1 at the temperature of during the image formation.

As shown in FIG. 5(b), in Comparison example, the operation in the load detecting mode is executed in the second position. At this time, a relationship of (drive current for driving fixing roller 1 itself):(drive current for driving pressing roller R2): (drive current for driving externally heating rollers R3 and R4) is as follows:

300 mA:800 mA:500 mA=3:8:5.

As shown in FIG. 6(a), it is assumed that, e.g., a ball bearing in one side of the externally heating roller R3 causes abnormality to increase the drive load of the externally heating roller R3 to result in an increase of 300 mA in current value of the fixing roller driving motor 314. In this case, an increase ratio of the current value of the fixing roller driving motor 314 is as follows:

300 mA/(300 mA+800 mA+500 mA)=18%.

As shown in FIG. 5(c), in Embodiment 1, the operation in the load detecting mode is executed in the second position. At this time, a relationship of (drive current for driving fixing roller 1 itself):(drive current for driving pressing roller R2):(drive current for driving externally heating rollers R3 and R4) is as follows:

300 mA:0 mA:500 mA=3:0:5.

As shown in FIG. 6(b), similarly as in Comparison example, it is assumed that the ball bearing in one side of the externally heating roller R3 causes abnormality to increase the drive load of the externally heating roller R3 to result in an increase of 300 mA in current value of the fixing roller driving motor 314. In this case, an increase ratio of the current value of the fixing roller driving motor 314 is as follows:

300 mA/(300 mA+0 mA+500 mA)=37%.

The externally heating rollers R3 and R4 are contacted to the fixing roller R1 at a relatively low pressure. For this reason, compared with the case where drive of the fixing roller R1 itself and drive of the pressing roller R2 causes abnormality, a drive current increase value in the case where drive of the externally heating rollers R3 and R4 causes abnormality is a relatively small value.

In the control in the following embodiments, the operation in the load detecting mode is executed in the third position, and therefore abnormality of the part can be found in an early stage by detecting even a small drive load increase amount of the externally heating rollers R3 and R4 with accuracy (with a high S/N ratio). Further, a contact member contacted to the fixing roller R1 is only the externally heating rollers R3 and R4, and therefore when the load fluctuation is generated, it becomes easy to identify the cause of the load fluctuation.

### (Control in Embodiment 1)

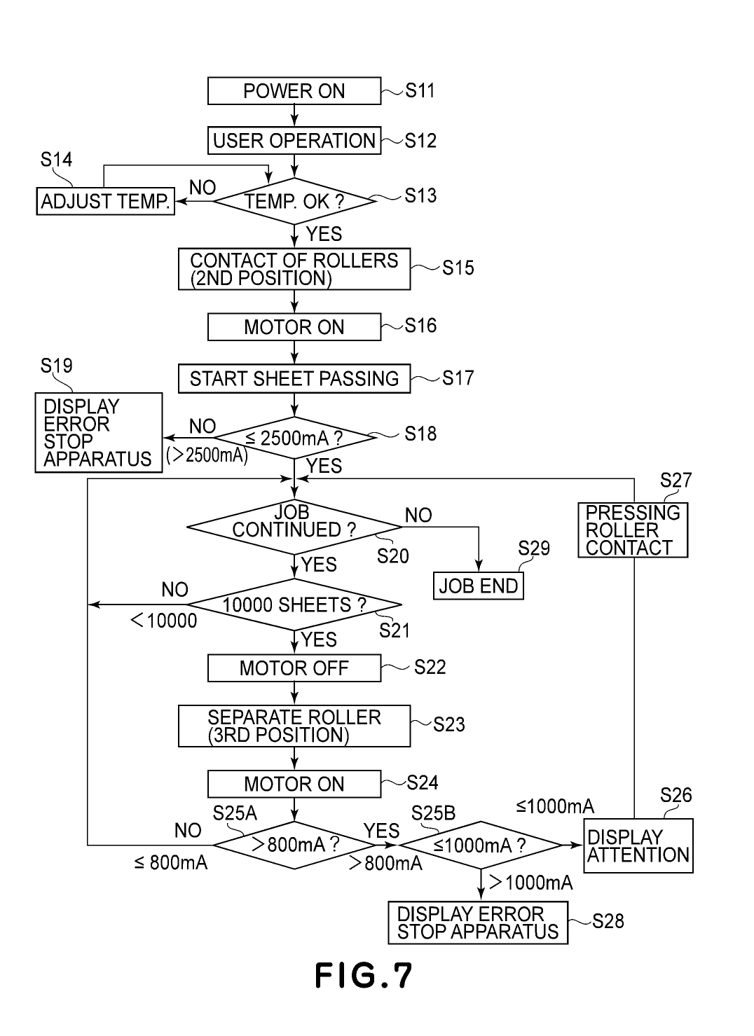

FIG. 7 is a flowchart of control in Embodiment 1. Control in Embodiment 1 is drive control in which the operation in the load detecting mode for detecting drive load abnormality of the externally heating rollers R3 and R4 is executed in an interruption manner during a continuous printing operation.

As shown in FIG. 7 with reference to FIG. 4, in a printing stand-by state (S11), when the user inputs the image forming job through the user operating portion 317 (S12), the controller 310 checks detection temperatures of the thermistors S1, S2 and S3 (S13).

In the case where the detection temperatures of the thermistors S1, S2 and S3 are less than the target temperature (NO of S13), the controller 310 turns on the halogen heaters H1, H2 and H3, respectively (S14), and then continues the ON state until the detection temperatures reach the target temperature.

When the detection temperatures of the thermistors S1, S2 and S3 reach the target temperature (YES of S13), the controller 310 brings the externally heating rollers R3 and R4 into contact with the fixing roller R1 as shown in FIG. 5(b) (S15).

The controller 310 turns on the fixing roller driving motor 314 to start rotation of the fixing roller R1 (S16), and then starts image formation to feed the recording material (S17). The controller 310 continues, during the image formation, detecting of the load of the fixing roller driving motor 314 every 50 msec by the fixing roller driving motor current detecting portion 315 (S18).

A detected current in a normal state is about 1600 mA, and therefore when the detected current continuously exceeds 2500 mA for 1 sec (NO of S18), the controller 310 displays warning at the user operating portion 317 and stops the image forming apparatus E. At the same time, the warning is displayed on a PC 320 connected with the controller 310 via a PC driver 319 through a network cable 318 (S19).

In the case where the detected current is below 2500 mA (YES of S18), the controller 310 continues remaining image formation while counting up a print (sheet passing) number of the image formation at a storing portion 316 (S20 and S21).

When the print number of the image formation reaches 10,000 sheets on an A4-size basis, the controller 310 stops the continuous image formation (S22), and then as shown in FIG. 5(c), only the pressing roller R2 is spaced from the fixing roller R1 to start the operation in the load detecting mode (S23).

The controller 310 actuates the fixing roller driving motor 314 to rotate the fixing roller R1 (S24), and then continues the detection of the load of the fixing roller driving motor 314 every predetermined time (50 msec in this embodiment) by the fixing roller driving motor current detecting portion 315 (S25A).

In the operation in the load detecting mode, the detected current in the normal state is about 500 mA, and therefore when the detected current continuously exceeds a predetermined value (800 mA in this embodiment) for a predetermined time (1 sec in this embodiment) (>800 mA (YES) of S25A), the detected current is discriminated (S25B).

In the case where the detected current exceeds 800 mA and is not more than 1000 mA 1000 mA of S25B), the controller 310 displays attention (for urging the user (operator) to replace the externally heating rollers) at the user operating portion 317 and also displays attention on the PC 320 through the network cable 318 (S26). Thereafter, as shown in FIG. 5(b), the pressing roller R2 is contacted to the fixing roller R1, so that the operation in the load detecting mode is ended (S27). Then, the continuous image formation is permitted until the image forming job is ended or until the sheet passing of 10,000 sheets on the A4-size basis is performed again.

In the case where the detected current exceeds 1000 mA (>1000 mA of S25B), the controller displays the warning at the user operating portion 317 and stops the image forming apparatus E. At the same time, the controller 310 displays the warning also on the PC 320 through the network cable 318 (S28).

In the control in Embodiment 1, the procedure goes to the operation in the load detecting mode every sheet passing of 10,000 sheets on the A4-size basis with respect to the print number of the image forming job, so that the drive load detection is made. This is because there is a tendency that the drive load of the externally heating roller R3 and R4 is fluctuated by the sheet passing of about 10,000 sheets.

Further, in the image forming apparatus E, the continuous image formation is interrupted every sheet passing of 5,000 sheets on the A4-size basis, and adjustment of an apparatus main assembly is made, and therefore at timing of once per two occurrences of adjusting timing of the apparatus main assembly, the operation in the load detecting mode is simultaneously performed. Thus, the number of occurrences of downtime is decreased.

Incidentally, a method of detecting the load based on the detection of the current value in the operation in the load detecting mode is not limited to that in Embodiment 1. For example, it is possible to effect similar evaluation by using a measuring means different from the above-described fixing roller driving motor current detecting portion 315, i.e., by using, e.g., a fixing roller driving motor torque detecting portion, a fixing roller rotational speed detecting portion or a fixing roller rotation non-uniformity detecting portion. The fixing roller driving motor current detecting portion 315 may also detect, in the case where a detected value exceeds a predetermined threshold, the number of occurrences of a locking signal within a period by generating the locking signal.

### Embodiment 2

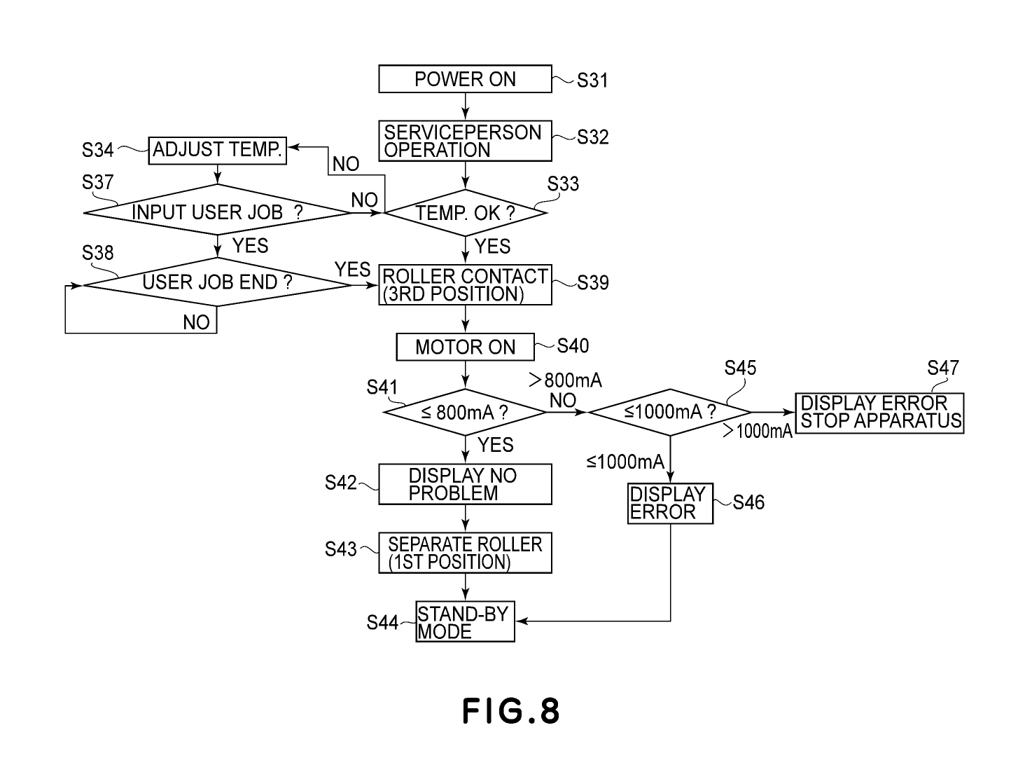

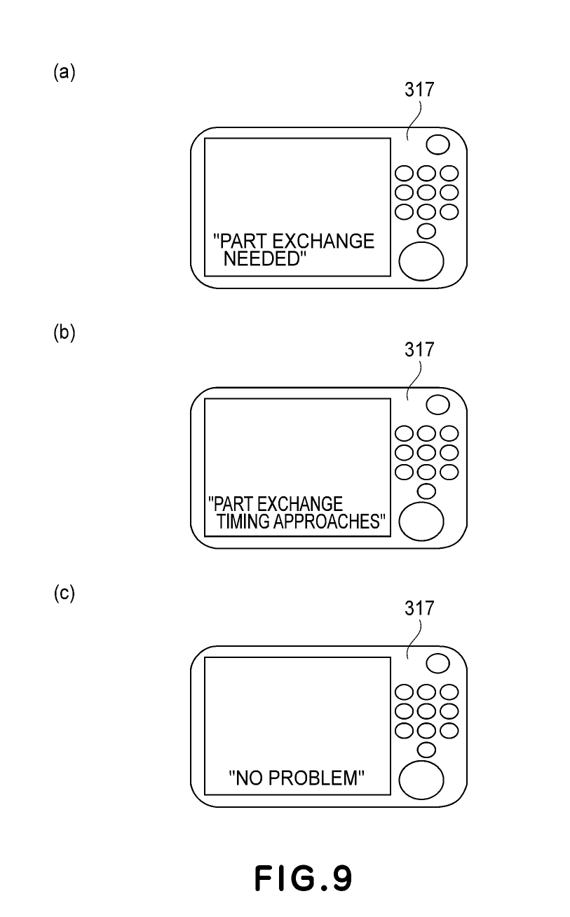

FIG. 8 is a flowchart of control in Embodiment 2. FIGS. 9(c), 9(b), and 9(c) are illustrations each showing a display state at the user operating portion. In Embodiment 1, every sheet passing of 10,000 sheets on the A4-size basis with respect to the print number of the image forming job, the operation in the load detecting mode was automatically executed in the interruption manner. On the other hand, in this embodiment, in a stop state of the image formation, the user (or a service person) inputs the instruction through the user operating portion 317, so that the operation in the load detecting mode at arbitrary timing.

As shown in FIG. 8 with reference to FIG. 4, when the user (service person) operates the user operating portion 317 to provide the instruction of start of the operation in the load detecting mode (S32), the controller 310 detects temperatures of the thermistors S1, S2 and S3 (S33).

In the case where the detected temperatures of the thermistors S1, S2 and S3 are not more than the target temperature (NO of S33), the controller 310 turns on the halogen heaters H1, H2 and H3, respectively, and then continues the heating until each of the detection temperatures reaches the target temperature. This is because when the drive load detection is performed after waiting until the detected temperatures of the thermistors S1, S2 and S3 reach the target temperature, the drive load of the fixing roller driving motor 314 is stabilized and thus it becomes possible to effect accurate evaluation.

Specifically, for reasons (1) to (4) shown below, the drive load detection is started after waiting until the detected temperatures reach the target temperature.

(1) With respect to grease applied between the heat-resistant bush 402 and the core metal of each of the externally heating rollers R3 and R4 or grease filled in the supporting flange 401, a viscosity and a pressing roller resistance are stabilized.

(2) Dimensions of the fixing roller R1 and the externally heating rollers R3 and R4 are set so that a degree of play is decreased by thermal expansion at the time when the detected temperatures reach the target temperature, and therefore at the time when the detected temperatures reach the target temperature, the drive load varying depending on the degree of play is stabilized.

(3) By heating the rollers until the detected temperatures reach the target temperature, hardness of the elastic layer and the surface layer of the fixing roller R1 is stabilized, and resistances in the nips between the fixing roller R1 and the externally heating roller R3 and between the fixing roller R1 and the externally heating roller R4 are stabilized.

(4) The fixing roller R1 has a large amount of storage of heat, and therefore a time required until the detected temperatures of the thermistors S1, S2 and S3 reach the target temperature is about 6 min., whereas a time required until the fixing roller R1 of 40° C. in surface temperature is cooled to 25° C. (room temperature) is 40 min. or more. For this reason, when the fixing roller R1 is heated to the target temperature, stable measurement can be started early.

When the detected temperatures of the thermistors S1, S2 and S3 reach the target temperature (YES of S33), the controller 310 brings the externally heating rollers R3 and R4 into contact with the fixing roller R1 to create the third position (S39).

The controller 310 actuates the fixing roller driving motor 314, and in a state in which the fixing roller R1 is rotated (S40), and detects the current (torque) by the fixing roller driving motor current detecting portion 315 (S41). Specifically, the controller 310 continues the detecting of the motor load every 50 msec.

When the detected current continuously exceeds 800 mA for 1 sec (NO of S41) and is 1000 mA or less (≦1000 mA of S45), the controller 310 outputs display, at the user operating portion 317, a message for urging the user (service person) to pay attention (S46). The display for urging the user to pay attention is outputted onto the input terminal (PC) 320 through the network cable 318 (S46).

When the detected current continuously exceeds 1000 mA for 1 sec (>1000 mA of S45), the controller 310 displays warning on the user operating portion 317 and the input terminal 320, and stops the image forming apparatus E due to emergency (S47).

In the case where the detected current is continuously 800 mA or less for 1 sec (YES of S41), the controller 310 displays, on the user operating portion 317 and the input terminal 320, a message that there is no abnormality with respect to the externally heating rollers R3 and R4 (S42). The current value in the third position in the normal state is about 500 mA.

The controller 310 spaces the externally heating rollers R3 and R4 from the fixing roller R1 to create the first position (S43), and then the procedure goes to an operation in a stand-by mode (S44).

When the service person provides the instruction to start the operation in the load detecting mode by operating the user operating portion 307 (NO of S33) and thereafter the user inputs the image forming job through the input terminal 320 (YES of S37), the image forming job is preferentially executed (S38). After the detected temperatures of the thermistors S1, S2 and S3 reach the target temperature and the image forming job is ended (completion of S38), the externally heating rollers R3 and R4 are contacted to the fixing roller R1 to create the third position (S39). That is, in the case where the image forming job is inputted by the user after the operation of the user operating portion 317 is inputted by the serviceperson and before the detected temperatures reach the target temperature, the drive load detecting operation is caused to be in stand-by until the image forming job is preferentially completed. However, the image forming job may also be caused to be in stand-by, and the drive load detecting operation may be preferentially completed.

As shown in FIG. 9(b), in the case where the current value of the fixing roller driving motor 314 shows the abnormality of the part (component), the image formation cannot be continued, and therefore a state in which image formation (fixing) is prohibited is created and at the same time, “warning” is displayed at the user operating portion 317. Specifically, as a condition for resuming the image formation, “PART EXCHANGE NEEDED” is displayed on the user operating portion 317.

As shown in FIG. 9(b), in the case where the current value of the fixing roller driving motor 314 shows advance of deterioration of the part, “ATTENTION” is displayed since the externally heating rollers R3 and R4 may preferably be exchanged (replaced) early. Specifically, “PART EXCHANGE TIMING APPROACHES” is displayed on the user operating portion 317.

As shown in FIG. 9(c), in the case where the current value of the fixing roller driving motor 314 is in a normal range, there is no obstacle to the image formation, and therefore NO PROBLEM″ is displayed. Specifically, NO PROBLEM″ is displayed on the user operating portion 317.

Incidentally, also in the case where a detection result is shown on the input terminal 320 through the network cable 318 or on a control terminal of a service station, display is made similarly as in the case where the detection result is shown on the user operating portion 317. A message to be displayed may only be required to notify whether the state of the part is necessary for the user or the serviceperson to exchange the part, whether the state of the part is such that timing of the exchange of the part approaches or whether the state of the part is such that there is no problem. The message may also be different from those shown in FIGS. 9(a), 9(b), and 9(c).

### Embodiment 3

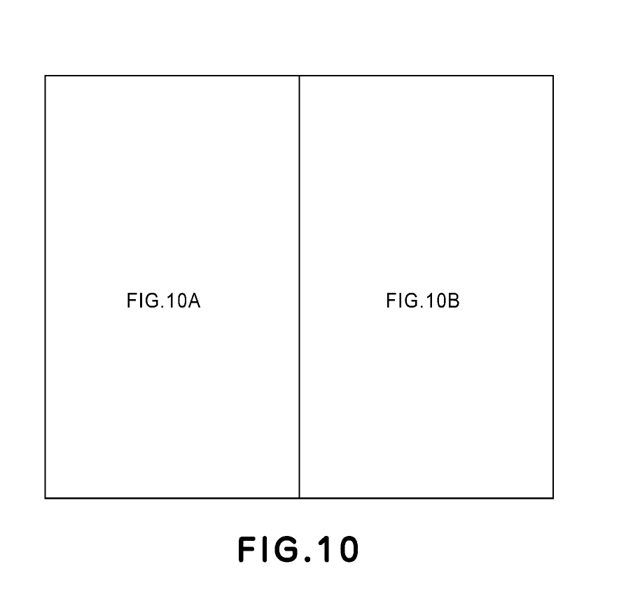

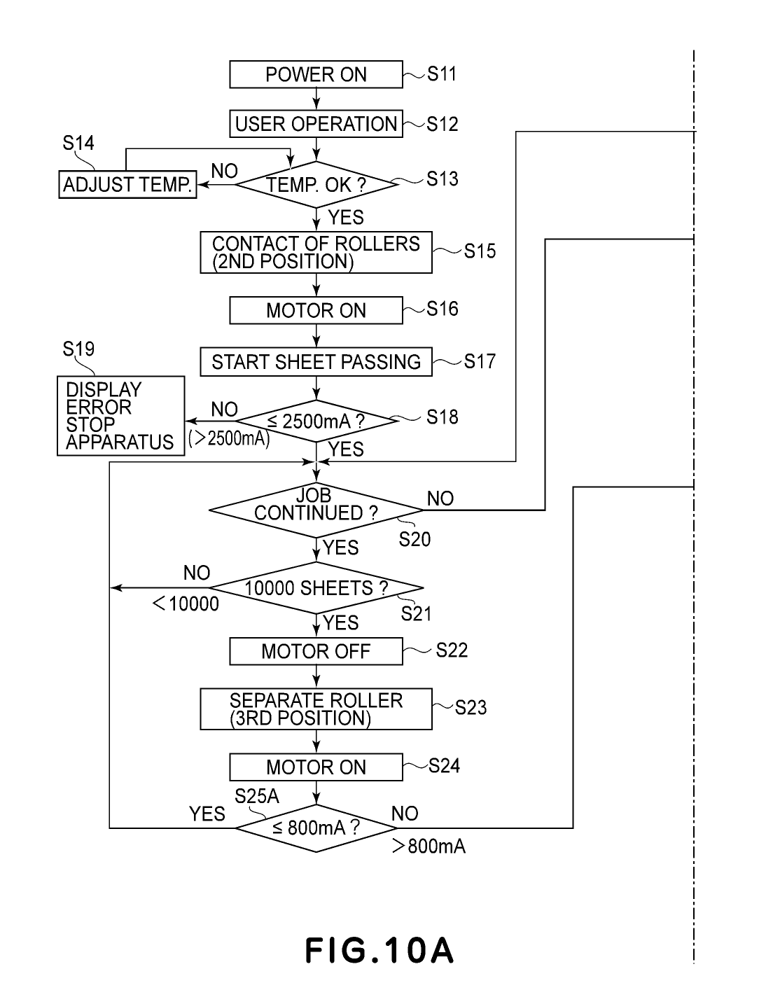

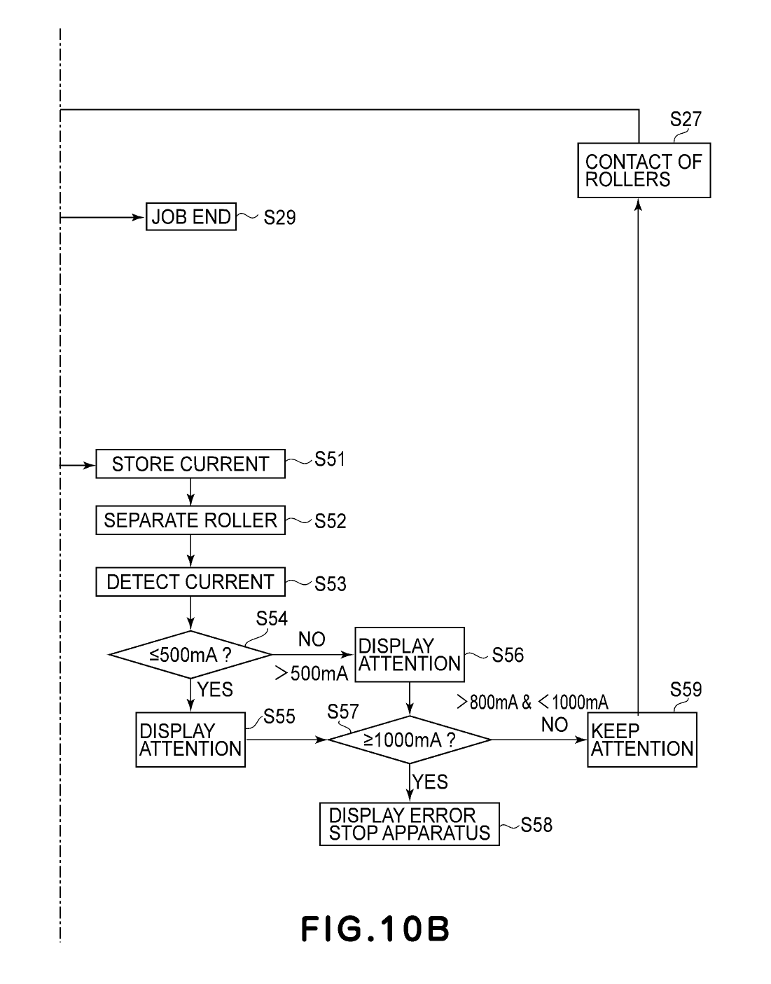

FIGS. 10A and 10B show a flowchart of control in Embodiment 3. Embodiment 3 is constituted by partly changing the control in Embodiment 1 in the fixing device F described with reference to FIGS. 1 to 5. Accordingly, in FIGS. 10A and 10B, control steps common to Embodiments 1 and 3 are represented by the same reference symbols as in FIG. 7 and will be omitted from redundant description.

In an operation in the load detecting mode in the control in Embodiment 3, similarly as in the control of Embodiment 1, the drive load is detected in the third position to detect drive abnormality of the externally heating rollers R3 and R4. However, thereafter the drive load detection is made in the first position, so that drive abnormality of the fixing roller R1 and the drive abnormality of the externally heating rollers R3 and R4 are discriminated.

As shown in FIG. 2, in each of a state in which the pressing roller R2 is spaced from the fixing roller 1 and a state in which the pressing roller R2 and the externally heating rollers R3 and R4 are spaced from the fixing roller 1, a driving torque of the fixing roller driving motor 314 is detected when the fixing roller driving motor 314 is operated for a predetermined time. In the case where the state of the driving torque detected in the state in which the pressing roller R2 is spaced from the fixing roller R1 corresponds to the abnormal state, the driving torque is detected in the state in which the pressing roller R2 and the externally heating rollers R3 and R4 are spaced.

The controller 310 is capable of discriminating the state of the externally heating rollers R3 and R4 on the basis of a value of a difference between the two driving torques of the fixing roller driving motor 304. The controller discriminates the state of the externally heating rollers R3 and R4 on the basis of the driving torque detected in the state in which the pressing roller R2 is spaced from the fixing roller R1 and the driving torque detected in the state in which the pressing roller R2 and the externally heating rollers R3 and R4 are spaced from the fixing roller R1.

The controller 310 discriminates that the state of the externally heating rollers R3 and R4 is abnormal in the following case. The case is such that the state of the driving torque detected in the state in which only the pressing roller R2 is spaced from the fixing roller R1 corresponds to the abnormal state and the state of the driving torque detected in the state in which the pressing roller R2 and the externally heating rollers R3 and R4 are spaced from the fixing roller R1 does not correspond to the abnormal state.

As shown in FIGS. 10A and 10B with reference to FIG. 4, when the print number of the image formation reaches 10,000 sheets on an A4-size basis (YES of S21), the controller 310 stops the continuous image formation (S22). As shown in FIG. 5(c), only the pressing roller R2 is spaced from the fixing roller R1 to start the operation in the load detecting mode (S23).

In the operation in the load detecting mode, the controller 310 actuates the fixing roller driving motor 314 to rotate the fixing roller R1 (S24), and then continues the detection of the load of the fixing roller driving motor 314 every 50 msec by the fixing roller driving motor current detecting portion 315 (S25A).

In the operation in the load detecting mode, in the case where the detected current continuously exceeds 800 mA for 1 sec (>800 mA of S25A), the detected current value is stored in the storing portion 316 (S51B).

In the operation in the load detecting mode, as shown in FIG. 5(a), the externally heating rollers R3 and R4 are spaced from the fixing roller R1 (S52), and then in the first position, a current value is detected by the fixing roller driving motor current detecting portion 315 (S53).

In the operation in the load detecting mode, a difference between an average of current values detected for 1 sec by continuously detecting the motor load every 50 msec in the first position and an average of corresponding current values in the third position is obtained (S54).

In the case where the difference is 500 mA or less (YES of S54), the controller 310 displays, at the user operating portion 317, a message to the effect that timing of exchange of the part associated with the drive of the fixing roller R1 approaches (S55). The display is similarly performed also on the input terminal 320 through the network cable 318.

In the case where the difference exceeds 500 mA (>500 mA (NO) of S54), the controller 310 displays, at the user operating portion 317, a message to the effect that timing of exchange of the part associated with the drive of the externally heating rollers R3 and R4 approaches (S56). The display is similarly performed also on the input terminal 320 through the network cable 318.

In the case where the difference exceeds 1000 mA or more (YES of S57), the controller 310 displays warning at the user operating portion 317, and stops the image forming apparatus E due to emergency (S58). The display is similarly performed also on the input terminal 320 through the network cable 318.

In the case where the difference is less than 1000 mA (<100 mA of S57), the controller 310 brings the pressing roller R2 and the externally heating rollers R3 and R4 into contact with the fixing roller R1 to create the second position as shown in FIG. 5(b) (S27), and then resumes the image formation.

According to the control in this embodiment, in the case where abnormality is found in the drive of the fixing roller R1, it becomes possible to discriminate part (component) failure of the fixing roller R1 and part failure of the externally heating rollers R3 and R4.

### Embodiment 4

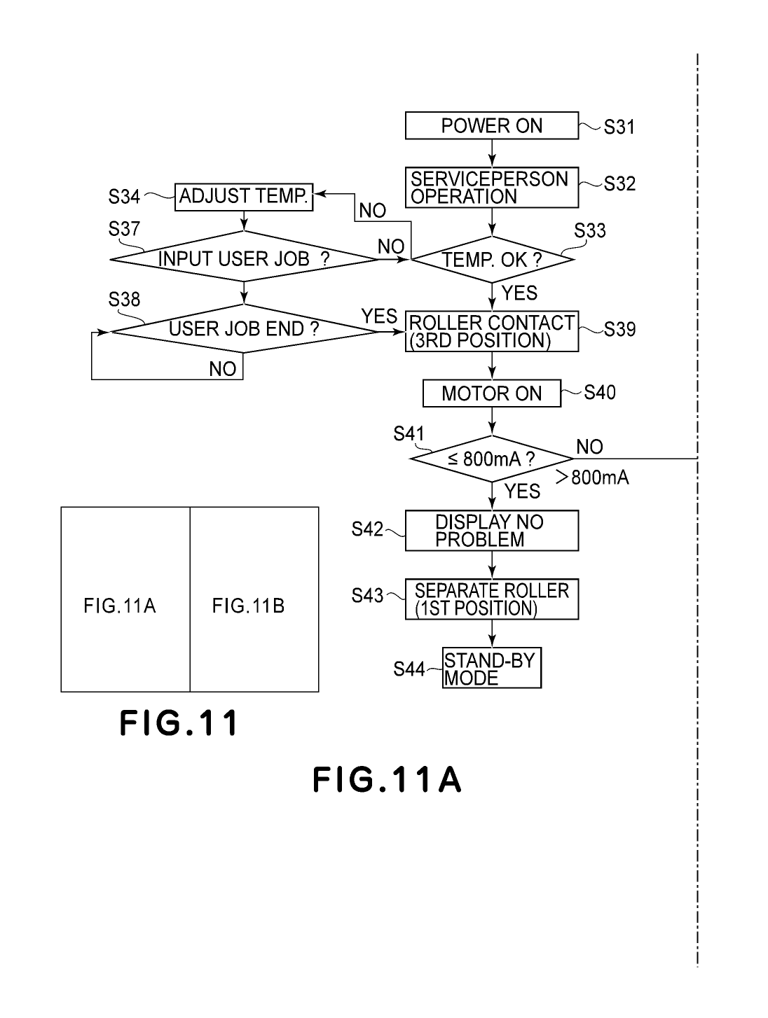

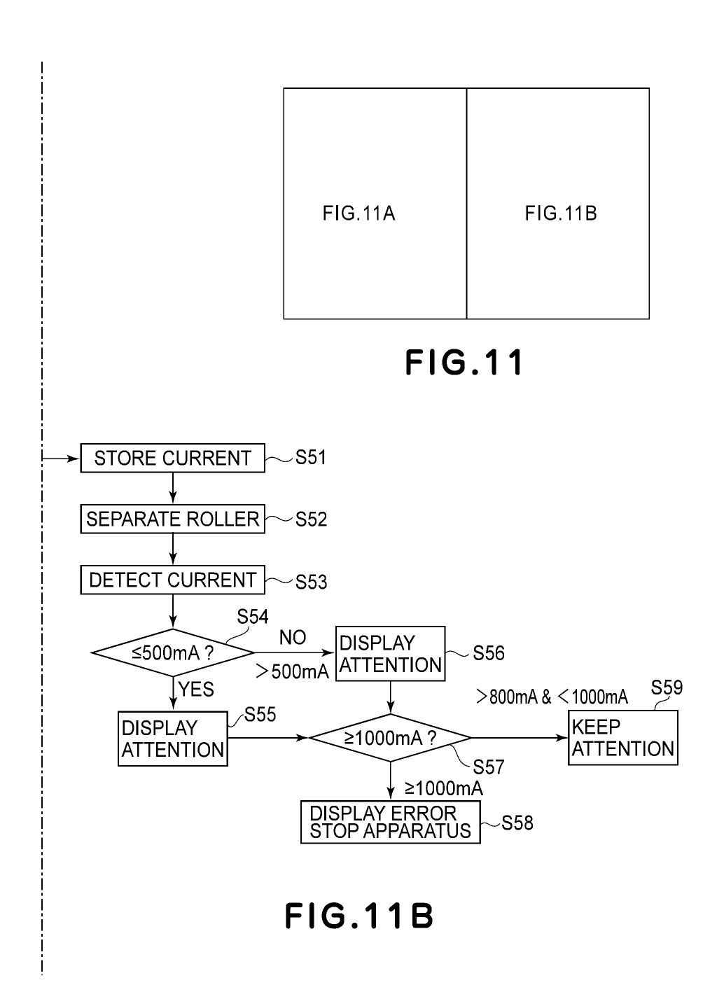

FIGS. 11A and 11B show a flowchart of control in Embodiment 4. Embodiment 4 is constituted by partly changing the control in Embodiment 2 in the fixing device F described with reference to FIGS. 1 to 5. Further, the changed control is the same as that of the control in Embodiment 3. Accordingly, in FIGS. 11A and 11B, control steps common to Embodiments 2 and 4 are represented by the same reference symbols as in FIG. 8 and will be omitted from redundant description. Further, control steps common to Embodiments 3 and 4 are represented by the same reference symbols as in FIGS. 10A and 10B and will be omitted from redundant description.

In an operation in the load detecting mode in the control in Embodiment 4, similarly as in the control of Embodiment 2, the operation is started by operation of the user operating portion 317 by the serviceperson, and the drive load is detected in the third position to detect drive abnormality of the externally heating rollers R3 and R4. However, thereafter the drive load detection is made in the first position, so that drive abnormality of the fixing roller R1 and the drive abnormality of the externally heating rollers R3 and R4 are discriminated.

As shown in FIGS. 11A and 11B with reference to FIG. 4, the controller 310 brings the externally heating rollers R3 and R4 into contact with the fixing roller R1 to create the third position (S39), and then performs detection of the current (torque) by the fixing roller driving motor current detecting portion 315 (S41).

In the operation in the load detecting mode, in the case where the detected current continuously exceeds 800 mA for 1 sec (>800 mA of S41), the detected current value is stored in the storing portion 316 (S51B).

As shown in FIG. 5(a), the controller 310 spaces the externally heating rollers R3 and R4 from the fixing roller R1 to create the first position (S52), and then detects the current (torque) by the fixing roller driving motor current detecting portion 315 (S53).

The controller 310 obtains a difference between an average of current values detected in the first position and an average of current values detected in the third position (S54).

In the case where the difference is 500 mA or less (YES of S54), the controller 310 displays, at the user operating portion 317, a message to the effect that timing of exchange of the part associated with the drive of the fixing roller R1 approaches (S55).

In the case where the difference exceeds 500 mA (>500 mA (NO) of S54), the controller 310 displays, at the user operating portion 317, a message to the effect that timing of exchange of the part associated with the drive of the externally heating rollers R3 and R4 approaches (S56).

In the case where the difference exceeds 1000 mA or more (≧1000 mA of S57), the controller 310 displays warning at the user operating portion 317, and stops the image forming apparatus E due to emergency (S58).

According to the control in this embodiment, in the case where abnormality is found in the drive of the fixing roller R1, it becomes possible to discriminate part (component) failure of the fixing roller R1 and part failure of the externally heating rollers R3 and R4.

### Embodiment 5

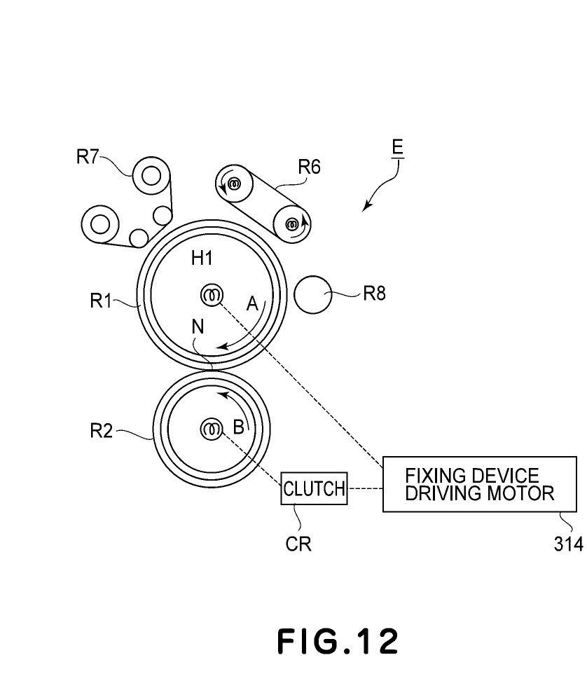

FIG. 12 is an illustration of a structure of a fixing device in Embodiment 5.

In Embodiment 1, in order to evaluate the rotation load of the externally heating rollers in the operation in the load detecting mode, the pressing roller was spaced from the fixing roller. In Embodiment 5, in place of the externally heating rollers, an externally heating belt is used. The externally heating belt is rotatably supported by two rollers at an inner surface thereof, and each of the two rollers is rotatably held by a bearing at longitudinal end portions thereof. Further, at a periphery of the fixing roller, a web cleaning device and a uniformly heating roller are provided.

Further, in order to evaluate the rotation load of the externally heating belt in the operation in the load detecting mode, the pressing roller, the web cleaning device and the uniformly heating roller are spaced from the fixing roller.

As shown in FIG. 12, a clutch CR as a drive transmission blocking mechanism is capable of blocking drive transmission from the fixing roller driving motor 314 to the pressing roller R2.

During heating of the recording material, the pressing roller R2 is rotated in interrelation with the fixing roller R1 by the clutch CR. The controller 310 turns of the clutch CR, and executes the operation in the load detecting mode in a state in which the drive transmission to the pressing roller R2 is blocked.

The web cleaning device R7 functioning as a cleaning mechanism is disposed movably toward and away from the fixing roller R1 by the contact-and-separation (moving mechanism), and is contacted to the fixing roller R1 during the heating of the recording material. The controller 310 executes the operation in the load detecting mode in a state in which the web cleaning device R7 is spaced from the fixing roller R1.

The uniformly heating roller R8 functioning as a rotatable heat diffusing member for diffusing heat, into a longitudinal direction, of a high-temperature portion of the fixing roller R1 is disposed movably toward and away from the fixing roller R1, and is contacted to the fixing roller R1 during heating of the recording material to alleviate a temperature difference with respect to the longitudinal direction. The controller 310 executes the operation in the load detecting mode in a state in which the uniformly heating roller R8 is spaced from the fixing roller R1.

In this way, by detecting the drive load in a state in which not only the pressing roller but also the cleaning device and the uniformly heating roller are spaced from the fixing roller, rotation abnormality of the externally heating belt can be accurately detected with an increased S/N ratio.

Further, in a position such that only the pressing roller R2 is contacted to the fixing roller R1, the drive load may also be detected. In this second position, it is assumed that (drive current for driving fixing roller 1 itself):(drive current for driving pressing roller R2):(drive current for driving externally heating rollers R3 and R4) is 300 mA:800 mA:500 mA. Under this condition, in the case where the drive load of the pressing roller R2 is increased by 300 mA, the current value is increased by 18%.

On the other hand, in the case where the drive load of the pressing roller R2 is similarly increased by 300 mA, in the second position such that only the pressing roller R2 is contacted to the fixing roller R1, the current value is increased by 18%, so that detection accuracy of the drive load can be enhanced.

In the above, Embodiments 1 to 5 to which the present invention is applicable were described specifically, but in each of Embodiments 1 to 5, various constitutions can be replaced with other constitutions within a range of the concept of the present invention.

For example, with respect to the fixing roller as the rotatable heating member and the pressing roller as the rotatable pressing member, at least one of these rollers may also be a belt member. Further, the mechanism for heating the rotatable externally-heating member is not limited to the halogen heater, but as the mechanism, a mechanism for heating the rotatable externally-heating member for electromagnetic induction heating using an exciting coil may also be employed.

Further, as the image heating apparatus, the fixing device was described as an example, but the fixing device can be similarly applied to also, e.g., a surface heating apparatus for adjusting gloss or surface property of a partly or completely fixed image.

Further, the fixing device is capable of being employed as, in addition to the constitution in which the fixing device is incorporated into the image forming apparatus, a single apparatus or component unit which is disposed and operated alone. Further, the image forming apparatus is not limited to the full-color image forming apparatus but may also be a monochromatic image forming apparatus. Further, the image forming apparatus is not limited to the printer but may also be a copying machine provided with an original reader, a facsimile machine for transferring image information, a multi-function machine having a plurality of functions of these machines, or the like machine.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 258331/2012 filed Nov. 27, 2012, which is hereby incorporated by reference.

What is claimed is:

1. An image heating apparatus comprising:
a rotatable heating member configured to heat a toner image on a sheet at a nip;
a driving mechanism configured to drive said rotatable heating member;
a rotatable pressing member configured to form the nip in press-contact with said rotatable heating member while being rotated by rotation of said rotatable heating member;
a first contact-and-separation mechanism configured to move said rotatable pressing roller toward and away from said rotatable heating member;
a rotatable externally-heating member provided outside said rotatable heating member and configured to heat said rotatable heating member in press-contact with said rotatable heating member while being rotated by rotation of said rotatable heating member;
a second contact-and-separation mechanism configured to move said rotatable externally-heating member toward and away from said rotatable heating member;
a detecting portion configured to detect information corresponding to a drive load exerted on said driving mechanism; and
a controller configured to actuate, when the information is detected by said detecting portion, said driving mechanism for a predetermined time in a state in which said rotatable externally-heating member is press-contacted to said rotatable heating member and in which said rotatable pressing member is spaced from said rotatable heating member,
wherein said controller controls, depending on an output of said detecting portion, whether or not image heating is prohibited.

2. An image heating apparatus according to claim 1, wherein said controller actuates said driving mechanism for the predetermined time in a state in which said rotatable externally-heating member and said rotatable pressing member are spaced from said rotatable heating member, and at the same time controls, depending on an output of said detecting portion obtained at that time, whether or not the image heating is prohibited.

3. An image heating apparatus according to claim 1, wherein said driving mechanism includes a motor and a transmitting mechanism configured to transmit a driving force of the motor to said rotatable heating member,
wherein the drive load is at least one of a rotational speed of said motor and a driving torque.

4. An image heating apparatus according to claim 1, wherein pressure of said rotatable pressing member exerted on said rotatable heating member is larger than pressure of said rotatable externally-heating member exerted on said rotatable heating member.

5. An image heating apparatus according to claim 1, further comprising:
a cleaning mechanism configured to clean external surface of said rotatable heating member, and
a third contact-and-separation mechanism configured to move said cleaning mechanism toward and away from said rotatable heating member,
wherein said controller actuates, when the information is detected by said detecting portion, said driving mechanism for the predetermined time in a state in which said cleaning mechanism is spaced from said rotatable heating member.

6. An image heating apparatus according to claim 1, further comprising a heater configured to heat said rotatable externally-heating member,
wherein said controller actuates, when the information is detected by said detecting portion, said driving mechanism for the predetermined time in a state in which said heater is spaced from said rotatable heating member.

7. An image heating apparatus according to claim 1, further comprising a bearing configured to rotatably bear said rotatable heating member.

8. An image heating apparatus according to claim 1, wherein said rotatable externally-heating member includes an endless belt, a roller configured to rotatably support the endless belt, and a bearing configured to rotatably bear the roller.

9. An image heating apparatus comprising:
a rotatable heating member configured to heat a toner image on a sheet at a nip;
a driving mechanism configured to drive said rotatable heating member;
a rotatable pressing member configured to form the nip in press-contact with said rotatable heating member while being rotated by rotation of said rotatable heating member;
a first moving mechanism configured to move said rotatable pressing roller so that said rotatable pressing member is movable to a first position wherein said rotatable pressing member is press-contacted to said rotatable heating member and a second position where said rotatable pressing member is spaced from said rotatable heating member;
a rotatable externally-heating member provided outside said rotatable heating member and configured to heat said rotatable heating member in press-contact with said rotatable heating member while being rotated by rotation of said rotatable heating member;
a second moving mechanism configured to move said rotatable externally-heating member so that said rotatable externally-heating member is movable to a third position where said rotatable externally-heating member is press-contacted to said rotatable heating member and a fourth position where said rotatable externally-heating member is spaced from said rotatable heating member;
an executing portion configured to execute an operation in a mode in which said driving mechanism is operated for a predetermined time in a state in which said rotatable pressing member is located in the second position and in which said rotatable externally-heating member is located in the third position;
a detecting portion configured to detect information corresponding to a drive load exerted on said driving mechanism; and
a sending portion configured to send, depending on an output of said detecting portion, a signal for notifying that said externally-heating member causes abnormal rotation.

10. An image heating apparatus according to claim 9, wherein said executing portion is capable of executing an operation in another mode in which said driving mechanism is actuated for the predetermined time in a state in which said rotatable externally-heating member and said rotatable pressing member are spaced from said rotatable heating member, and
wherein said sending portion sends the signal depending on an output of said detecting portion obtained in each of the mode and another mode.

11. An image heating apparatus according to claim 9, wherein said driving mechanism includes a motor and a transmitting mechanism configured to transmit a driving force of the motor to said rotatable heating member,
wherein the drive load is at least one of a rotational speed of said motor and a driving torque.

12. An image heating apparatus according to claim 9, wherein pressure of said rotatable pressing member exerted on said rotatable heating member is larger than pressure of said rotatable externally-heating member exerted on said rotatable heating member.

13. An image heating apparatus according to claim 9, further comprising:
a cleaning mechanism configured to clean external surface of said rotatable heating member, and
a third contact-and-separation mechanism configured to move said cleaning mechanism toward and away from said rotatable heating member,
wherein said executing portion places, when said executing portion executes the operation in the mode, said cleaning mechanism in a state in which said cleaning mechanism is spaced from said rotatable heating member.

14. An image heating apparatus according to claim 9, further comprising a heater configured to heat said rotatable externally-heating member,
wherein said controller actuates, when the information is detected by said detecting portion, said driving mechanism for the predetermined time in a state in which said heater is spaced from said rotatable heating member.

15. An image heating apparatus according to claim 9, further comprising an operating portion configured to be provided with a key for permitting an operator to provide an instruction to execute the operation in the mode,
wherein said executing portion executes the operation in the mode on the basis of the instruction at the operating portion.

16. An image heating apparatus according to claim 15, wherein said operating portion displays, on the basis of a signal from said sending portion, a message for urging the operator to replace said rotatable externally-heating member.

17. An image heating apparatus according to claim 9, further comprising a bearing configured to rotatably bear said rotatable heating member.

18. An image heating apparatus according to claim 9, wherein said rotatable externally-heating member includes an endless belt, a roller configured to rotatably support the endless belt, and a bearing configured to rotatably bear the roller.
